(19) United States
(12) Patent Application Publication
(10) Pub. No.: US 2012/0029930 A1
(43) Pub. Date: Feb. 2, 2012

(54) Methods and Systems for Importing Data into a Database Associated with a Cochlear Implant Fitting Software Product

(75) Inventors: Guillermo A. Calle, Moorpark, CA (US); Fernando Chapa, Harold, CA (US); Carlos O. Hernandez, Stevenson Ranch, CA (US)

(73) Assignee: Advanced Bionics AG, c/o Froriep Renggli, Zug (CH)

(21) Appl. No.: 12/847,084

(22) Filed: Jul. 30, 2010

(51) Int. Cl. G06Q 50/00; G06F 17/30

(52) U.S. Cl. 705/2; 707/803; 707/E17.005

(57) ABSTRACT

A method includes a fitting subsystem maintaining patient data in a primary database associated with a primary schema, receiving an export file representative of additional patient data extracted from a source database associated with a source schema and maintained by another fitting subsystem, importing the additional patient data represented by the export file into a database partition associated with the source schema, upgrading, in response to the importing, the database partition to be associated with the primary schema, and merging the additional patient data included in the upgraded database partition with the patient data in the primary database. Corresponding methods and systems are also described.

### BACKGROUND INFORMATION

The natural sense of hearing in human beings involves the use of hair cells in the cochlea that convert or transduce acoustic signals into auditory nerve impulses. Hearing loss, which may be due to many different causes, is generally of two types: conductive and sensorineural. Conductive hearing loss occurs when the normal mechanical pathways for sound to reach the hair cells in the cochlea are impeded. These sound pathways may be impeded, for example, by damage to the auditory ossicles. Conductive hearing loss may often be overcome through the use of conventional hearing aids that amplify sound so that acoustic signals can reach the hair cells within the cochlea. Some types of conductive hearing loss may also be treated by surgical procedures.

Sensorineural hearing loss, on the other hand, is caused by the absence or destruction of the hair cells in the cochlea which are needed to transduce acoustic signals into auditory nerve impulses. People who suffer from sensorineural hearing loss may be unable to derive significant benefit from conventional hearing aid systems, no matter how loud the acoustic stimulus. This is because the mechanism for transducing sound energy into auditory nerve impulses has been damaged. Thus, in the absence of properly functioning hair cells, auditory nerve impulses cannot be generated directly from sounds.

To overcome sensorineural hearing loss, numerous cochlear implant systems—or cochlear prostheses—have been developed. Cochlear implant systems bypass the hair cells in the cochlea by presenting electrical stimulation directly to the auditory nerve fibers by way of one or more channels formed by an array of electrodes implanted in the cochlea. Direct stimulation of the auditory nerve fibers leads to the perception of sound in the brain and at least partial restoration of hearing function.

When a cochlear implant system is initially implanted in a patient, and during follow-up tests and checkups thereafter, it is usually necessary to fit the cochlear implant system to the patient. Fitting of a cochlear implant system to a patient is typically performed by an audiologist or the like who utilizes fitting software to present various stimuli to the patient and relies on subjective feedback from the patient as to how such stimuli are perceived.

During a fitting procedure, patient data specific to a particular cochlear implant patient is used and/or acquired by the fitting system. Such data may include personal information associated with the patient, data representative of one or more sound processing programs associated with the patient, and/or any other type of data specific to the patient. Patient data is typically maintained in a database associated with the fitting software. The structure of the database is defined by a schema, which may describe the type and layout of each item of data stored in the database as well as the interdependencies between the data and/or any constraints that may be associated with the data.

It is often desirable to transfer patient data from one database to another, such as when a patient transfers from one clinic to another or when patient data is to be sent to a support center for troubleshooting. To this end, the patient data may be extracted from the database and saved in an export file, which represents a portable file defined to have a compatible schema to that used to define the database. The export file may then be transferred (e.g., emailed or otherwise electronically transferred) to a recipient entity (e.g., another clinic, etc.) and imported into a database maintained by the recipient entity.

As the fitting software evolves over time, it is often desirable to store additional information in a database associated with the fitting software and/or to assign different meanings to existing data within the database. This change in the database is accomplished by upgrading the schema associated with the database. However, because the schema used to create an export file is frozen at the time the file is created, it is often not possible to import an earlier revision export file into an upgraded database due to the potential conflict in the structure of the data, i.e., a schema mismatch.

### SUMMARY

An exemplary method of importing data into a database associated with a cochlear implant fitting software product includes a fitting subsystem 1) maintaining patient data in a primary database associated with a primary schema, 2) receiving an export file representative of additional patient data extracted from a source database associated with a source schema and maintained by another fitting subsystem, 3) importing the additional patient data represented by the export file into a database partition associated with the source schema, 4) upgrading, in response to the importing, the database partition to be associated with the primary schema, and 5) merging the additional patient data included in the upgraded database partition with the patient data in the primary database.

Another method of importing data into a database includes at least one computing device 1) maintaining data in a primary database associated with a primary schema, 2) receiving an export file representative of additional data extracted from a source database associated with a source schema, 3) importing the additional data represented by the export file into a database partition associated with the source schema, 4) upgrading, in response to the importing, the database partition to be associated with the primary schema, and 5) merging the additional data included in the upgraded database partition with the data in the primary database.

A system for importing data into a database associated with a cochlear implant fitting software product includes a database management facility configured to maintain patient data in a primary database associated with a primary schema and an import facility communicatively coupled to the database management facility. The import facility is configured to receive an export file representative of additional patient data extracted from a source database associated with a source schema and maintained by another fitting subsystem, and import the additional patient data represented by the export file into a database partition associated with the source schema. In response to the importing, the database management facility is further configured to upgrade the database partition to be associated with the primary schema and merge the additional patient data included in the upgraded database partition with the patient data in the primary database.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary cochlear implant system according to principles described herein.

FIG. 2 illustrates an exemplary cochlear implant fitting system according to principles described herein.

FIG. 3 illustrates exemplary components of an exemplary fitting subsystem according to principles described herein.

FIG. 4 illustrates exemplary components of a sound processor according to principles described herein.

FIG. 5 illustrates an exemplary implementation of the cochlear implant fitting system of FIG. 2 according to principles described herein.

FIG. 6 illustrates an exemplary method of importing patient data into a database associated with a cochlear implant fitting software product according to principles described herein.

FIG. 7 shows a source database that may be associated with a fitting software product used by a fitting subsystem to fit a cochlear implant system to a patient according to principles described herein.

FIG. 8 shows a primary database according to principles described herein.

FIG. 9A shows a database partition residing within a primary database according to principles described herein.

FIG. 9B shows a database partition residing within a database separate from a primary database according to principles described herein.

FIG. 10 shows that a recipient fitting subsystem may import patient data represented by an export file into a database partition according to principles described herein.

FIG. 11 shows that upgrade scripts may be applied to a database partition to upgrade the database partition to a new version according to principles described herein.

FIG. 12 shows a merging of patient data with patient data already maintained within a primary database according to principles described herein.

FIG. 13 shows a primary database after patient data has been merged therein according to principles described herein.

FIG. 14 illustrates an exemplary computing device according to principles described herein.

FIG. 15 illustrates an exemplary method of importing data represented by an export file into a database that is associated with a different schema than that associated with the export file according to principles described herein.

### DETAILED DESCRIPTION

Methods and systems for importing data into a database associated with a cochlear implant fitting software product are described herein. As described in more detail below, a fitting subsystem may maintain patient data in a primary database associated with a primary schema. The patient data may be associated with one or more patients and used to fit one or more cochlear implant systems to one or more patients. The fitting subsystem may further receive an export file representative of additional patient data extracted from a source database associated with a source schema and maintained by another fitting subsystem. The additional patient data may be associated with an additional patient (e.g., a patient not previously associated with the fitting subsystem). The fitting subsystem may then import the additional patient data represented by the export file into a database partition associated with the source schema, upgrade the database partition to be associated with the primary schema, and merge the additional patient data included in the upgraded database partition with the patient data in the primary database.

As used herein, the term “schema” may refer to one or more predefined rules governing the structure and type of data that may be included in a database. A schema may further define and/or describe the type and layout of each item of data stored in the database as well as the interdependencies between the data and/or any constraints that may be associated with the data. Hence, a database “associated with a schema” means that the database is defined by the schema and that data may be maintained within the database in accordance with the schema.

As used herein, a “database partition” refers to an independent portion of a database and may be associated with (e.g., defined by) a distinct schema. Multiple database partitions each associated with a distinct schema may reside within the same database.

Numerous advantages may be associated with the methods and systems described herein. For example, by importing patient data represented by an export file into a database partition associated with the same source schema as the source database, one or more upgrade scripts may be applied to the database partition in order to upgrade the imported data to the primary schema utilized by the fitting subsystem. As will be described in more detail below, this obviates the need to generate and apply one or more upgrade scripts to the export file itself, which process may be difficult, cumbersome, and error prone.

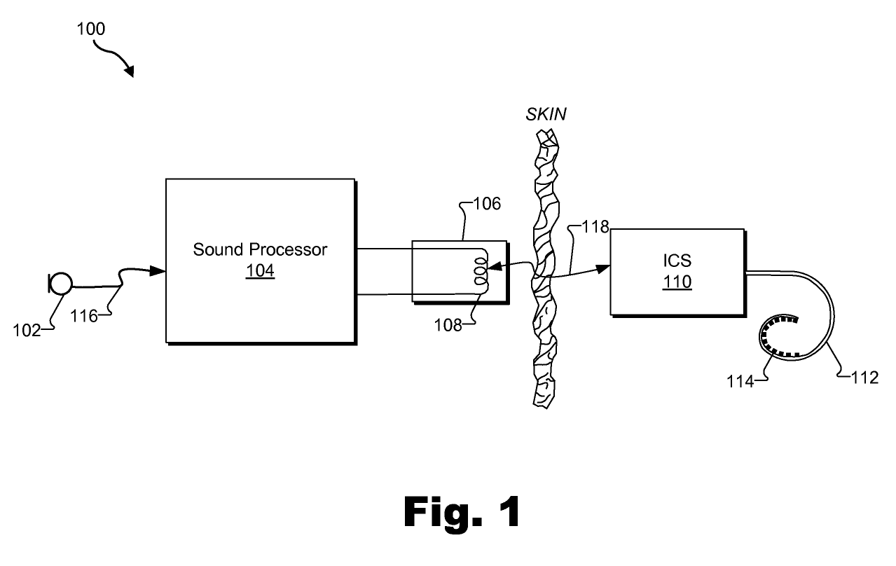

To facilitate an understanding of the methods and systems described herein, an exemplary cochlear implant system 100 will be described in connection with FIG. 1. As shown in FIG. 1, cochlear implant system 100 may include a microphone 102, a sound processor 104, a headpiece 106 having a coil 108 disposed therein, an implantable cochlear stimulator (“ICS”) 110, and a lead 112 with a plurality of electrodes 114 disposed thereon. Additional or alternative components may be included within cochlear implant system 100 as may serve a particular implementation.

As shown in FIG. 1, microphone 102, sound processor 104, and headpiece 106 may be located external to a cochlear implant patient. In some alternative examples, microphone 102 and/or sound processor 104 may be implanted within the patient. In such configurations, the need for headpiece 106 may be obviated.

Microphone 102 may detect an audio signal and convert the detected signal to a corresponding electrical signal. The electrical signal may be sent from microphone 102 to sound processor 104 via a communication link 116, which may include a telemetry link, a wire, and/or any other suitable communication link.

Sound processor 104 is configured to direct implantable cochlear stimulator 110 to generate and apply electrical stimulation (also referred to herein as “stimulation current”) to one or more stimulation sites within a cochlea of the patient. To this end, sound processor 104 may process the audio signal detected by microphone 102 in accordance with a selected sound processing strategy to generate appropriate stimulation parameters for controlling implantable cochlear stimulator 110. Sound processor 104 may include or be implemented by a behind-the-ear (“BTE”) unit, a portable speech processor (“PSP”), and/or any other sound processing unit as may serve a particular implementation. Exemplary components of sound processor 104 will be described in more detail below.

Sound processor 104 may be configured to transcutaneously transmit one or more control parameters and/or one or more power signals to implantable cochlear stimulator 110 with coil 108 by way of a communication link 118. These control parameters may be configured to specify one or more stimulation parameters, operating parameters, and/or any other parameter by which implantable cochlear stimulator 110 is to operate as may serve a particular implementation. Exemplary control parameters include, but are not limited to, stimulation current levels, volume control parameters, program selection parameters, operational state parameters (e.g., parameters that turn a sound processor and/or an implantable cochlear stimulator on or off), audio input source selection parameters, fitting parameters, noise reduction parameters, microphone sensitivity parameters, microphone direction parameters, pitch parameters, timbre parameters, sound quality parameters, most comfortable current levels (“M levels”), threshold current levels, channel acoustic gain parameters, front and backend dynamic range parameters, current steering parameters, pulse rate values, pulse width values, frequency parameters, amplitude parameters, waveform parameters, electrode polarity parameters (i.e., anode-cathode assignment), location parameters (i.e., which electrode pair or electrode group receives the stimulation current), stimulation type parameters (i.e., monopolar, bipolar, or tripolar stimulation), burst pattern parameters (e.g., burst on time and burst off time), duty cycle parameters, spectral tilt parameters, filter parameters, and dynamic compression parameters. Sound processor 104 may also be configured to operate in accordance with one or more of the control parameters.

As shown in FIG. 1, coil 108 may be housed within headpiece 106, which may be affixed to a patient's head and positioned such that coil 108 is communicatively coupled to a corresponding coil included within implantable cochlear stimulator 110. In this manner, control parameters and power signals may be wirelessly transmitted between sound processor 104 and implantable cochlear stimulator 110 via communication link 118. It will be understood that data communication link 118 may include a bi-directional communication link and/or one or more dedicated uni-directional communication links. In some alternative embodiments, sound processor 104 and implantable cochlear stimulator 110 may be directly connected with one or more wires or the like.

Implantable cochlear stimulator 110 may be configured to generate electrical stimulation representative of an audio signal detected by microphone 102 in accordance with one or more stimulation parameters transmitted thereto by sound processor 104. Implantable cochlear stimulator 110 may be further configured to apply the electrical stimulation to one or more stimulation sites within the cochlea via one or more electrodes 114 disposed along lead 112. In some examples, implantable cochlear stimulator 110 may include a plurality of independent current sources each associated with a channel defined by one or more of electrodes 114. In this manner, different stimulation current levels may be applied to multiple stimulation sites simultaneously by way of multiple electrodes 114. In such examples, cochlear implant system 100 may be referred to as a “multi-channel cochlear implant system.”

To facilitate application of the electrical stimulation generated by implantable cochlear stimulator 110, lead 112 may be inserted within a duct of the cochlea such that electrodes 114 are in communication with one or more stimulation sites within the cochlea. As used herein, the term “in communication with” refers to electrodes 114 being adjacent to, in the general vicinity of, in close proximity to, directly next to, or directly on the stimulation site. Any number of electrodes 114 (e.g., sixteen) may be disposed on lead 112 as may serve a particular implementation.

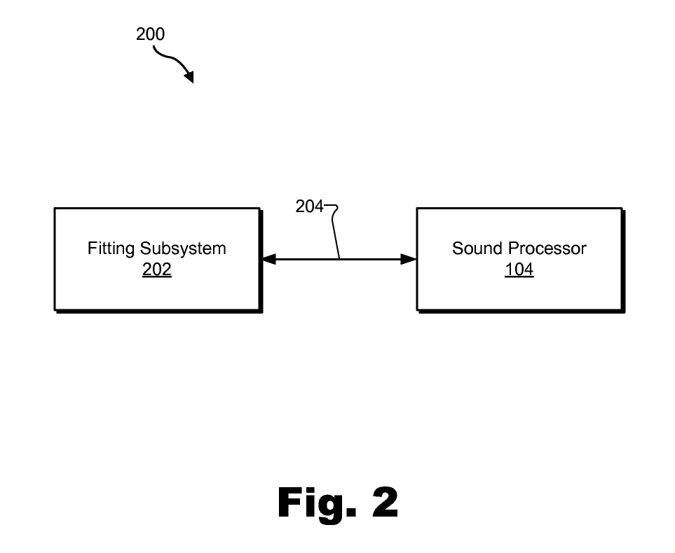

FIG. 2 illustrates an exemplary cochlear implant fitting system 200 (or simply “fitting system 200”) that may be used to fit sound processor 104 to a patient. As used herein, the terms “fitting a sound processor to a patient” and “fitting a cochlear implant system to a patient” will be used interchangeably to refer to performing one or more fitting operations associated with sound processor 104 and/or any other component of cochlear implant system 100. Such fitting operations may include, but are not limited to, adjusting one or more control parameters by which sound processor 104 and/or implantable cochlear stimulator 110 operate, measuring one or more electrode impedances, performing one or more neural response detection operations, and/or performing one or more diagnostics procedures associated with the cochlear implant system.

As shown in FIG. 2, fitting system 200 may include a fitting subsystem 202 configured to be selectively and communicatively coupled to sound processor 104 of cochlear implant system 100 by way of a communication link 204. Fitting subsystem 202 and sound processor 104 may communicate using any suitable communication technologies, devices, networks, media, and protocols supportive of data communications.

Fitting subsystem 202 may be configured to perform one or more of the fitting operations described herein. To this end, fitting subsystem 202 may be implemented by any suitable combination of computing and communication devices including, but not limited to, a fitting station, a personal computer, a laptop computer, a handheld device, a mobile device (e.g., a mobile phone), a clinician's programming interface (“CPI”) device, and/or any other suitable component as may serve a particular implementation. In some examples, fitting subsystem 202 may utilize a fitting software product to perform one or more of the fitting operations described herein. An exemplary implementation of fitting subsystem 202 will be described in more detail below.

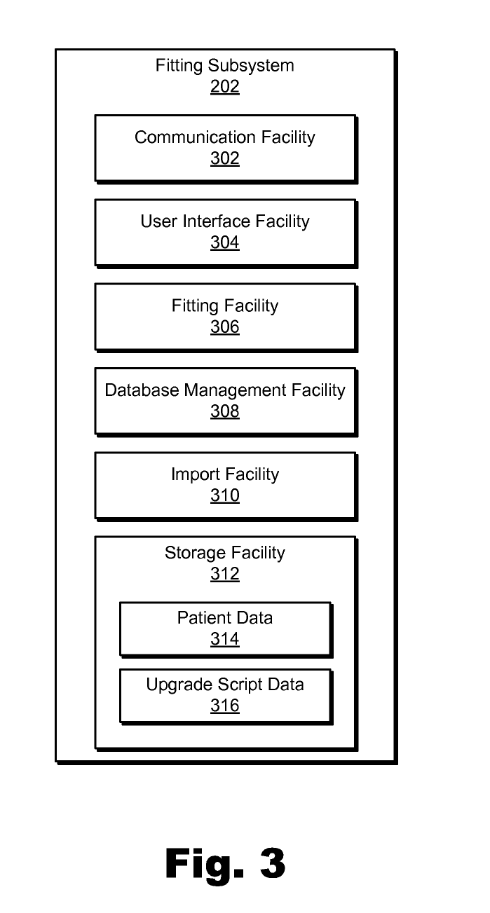

FIG. 3 illustrates exemplary components of fitting subsystem 202. As shown in FIG. 3, fitting subsystem 202 may include a communication facility 302, a user interface facility 304, a fitting facility 306, a database management facility 308, an import facility 310, and a storage facility 312, which may be communicatively coupled to one another using any suitable communication technologies. Each of these facilities will now be described in more detail.

Communication facility 302 may be configured to facilitate communication between fitting subsystem 202 and sound processor 104. For example, communication facility 302 may be implemented by a CPI device, which may include any suitable combination of components configured to allow fitting subsystem 202 to interface and communicate with sound processor 104. Communication facility 302 may additionally or alternatively include one or more transceiver components configured to wirelessly transmit data (e.g., program data and/or control parameter data) to sound processor 104 and/or wirelessly receive data (e.g., feedback data, impedance measurement data, neural response data, etc.) from sound processor 104.

Communication facility 302 may additionally or alternatively be configured to facilitate communication between fitting subsystem 302 and one or more other devices. For example, communication facility 302 may be configured to facilitate communication between fitting subsystem 302 and one or more computing devices (e.g., by way of the Internet and/or one or more other types of networks), reference implants, and/or any other computing device as may serve a particular implementation.

User interface facility 304 may be configured to provide one or more user interfaces configured to facilitate user interaction with fitting subsystem 202. For example, user interface facility 304 may provide a graphical user interface (“GUI”) through which one or more functions, options, features, and/or tools associated with one or more fitting operations described herein may be provided to a user and through which user input may be received. In certain embodiments, user interface facility 304 may be configured to provide the GUI to a display device (e.g., a computer monitor) for display.

Fitting facility 306 may be configured to perform one or more of the fitting operations described herein. For example, fitting facility 306 may be configured to adjust one or more control parameters by which sound processor 104 and/or implantable cochlear stimulator 110 operate, direct sound processor 104 to measure one or more electrode impedances, perform one or more neural response detection operations, and/or perform one or more diagnostics procedures associated with cochlear implant system 100. In some examples, fitting facility 306 may execute a fitting software product in order to perform one or more of the fitting operations described herein.

Database management facility 308 may be configured to manage one or more databases associated with a fitting software product (also referred to herein simply as “fitting software”) used by fitting subsystem 202 to fit a cochlear implant patient to a patient. For example, database management facility 308 may perform one or more database operations on the one or more databases and/or data stored in the one or more databases.

In some examples, database management facility 308 may maintain data (e.g., patient data) in a primary database associated with a fitting software product. The patient data may be associated with one or more patients and used to fit one or more cochlear implant systems to the one or more patients.

The primary database may be associated with a primary schema. In other words, patient data may be stored within the primary database in accordance with the primary schema. The primary database (and all other databases described herein) may be implemented using any suitable database application. For example, the databases described herein may be implemented using Microsoft Structured Query Language (“SQL”) and/or any other suitable database application.

The primary schema may be modified (e.g., upgraded) to accommodate new and/or different features that are introduced with one or more upgrades of the fitting software associated with the primary database. For example, an upgraded version of the fitting software may be released from time to time by a maker of the fitting software. With each release, the primary database may be upgraded to be associated with a new schema associated with the upgraded fitting software. In some examples, upgrading of the primary database may be performed by applying an upgrade script to the data maintained within the database. As used herein, an “upgrade script” includes code configured to convert or migrate data maintained in a database from being associated with an outdated schema to being associated with a more recent schema (e.g., a current schema). An upgrade script may alternatively be used to revert data from being associated with a more recent schema to being associated with a relatively more outdated schema.

In some examples, it may be desirable to export data from the primary database maintained by database management facility 308. For example, a patient may move from a one clinic to another. Each clinic may use separate instances of the fitting software and may have separate primary databases. Hence, it may be desirable to export patient data associated with the patient so that the patient data may be imported into the primary database maintained by the new clinic. To this end, database management facility 308 may generate an export file representative of data (e.g., patient data associated with a particular patient) extracted from the primary database. The export file may be in any suitable portable format (e.g., extensible markup language (“XML”)). In this manner, the export file may be easily written to a portable storage medium (e.g., a disc, flash drive, etc.), electronically transmitted (e.g., by way of email, electronic file transfer, etc.), and/or otherwise provided to a recipient fitting subsystem 202.

Import facility 110 may be configured to facilitate importing of data represented by an export file into the primary database maintained by database management facility 308. For example, import facility 110 may facilitate importing of patient data associated with a cochlear implant patient into the primary database.

In some examples, import facility 110 may receive, by way of communication facility 102, an export file representative of patient data extracted from a source database associated with a source schema and maintained by a source fitting subsystem. Import facility 110 may then import the patient data represented by the export file into the primary database.

In some instances, the source schema associated with data represented by the export file may be different than the primary schema. For example, the source schema may be associated with an initial version of a software product and the primary schema may be associated with an upgraded version of the software product. If the export file represents patient data associated with a different schema than the primary schema, the patient data may not be usable by the upgraded software product.

In some instances, fitting subsystem 202 may attempt to upgrade the export file itself prior to being imported into the primary database in order to make the patient data represented by the export file compatible with the primary schema. Due to the inherent differences between export files and data maintained in a database (e.g., an export file may be in XML format while the data may be maintained in an SQL database or the like), an upgrade script separate and distinct from the upgrade script used to upgrade data already stored within a database has to be applied to the export file. Developing and maintaining upgrade scripts for export files, in addition to those used to upgrade databases, can be cumbersome, make it difficult to troubleshoot software glitches and bugs, and create confusion.

Hence, the systems and methods described herein may facilitate use of a single type of upgrade script to upgrade data maintained within a primary database and data represented by an export file. To this end, database management facility 308 may analyze an export file received by import facility 110 and detect whether the source schema is different than the primary schema. If the two schemas are different, database management facility 308 may create a database partition associated with the source schema into which the data represented by the export file is imported. As will be described in more detail below, the database partition may be created within the primary database and/or in within a database separate from the primary database. In some alternative examples, the database partition may already be in existence, thereby obviating the need for its creation by database management facility 308.

Import facility 310 may import the data represented by the export file into the database partition, which is associated with the same source schema as the data represented by the export file. Database management facility 308 may then upgrade the database partition (i.e., the data included in the database partition) to be associated with the primary schema. The upgrading of the database partition may be performed by applying one or more upgrade scripts to the database partition and/or in any other manner as may serve a particular implementation.

After the database partition has been upgraded to be associated with the primary schema, database management facility 308 may merge the imported data included in the upgraded database partition with the data maintained in the primary database. The imported data may then be used by fitting subsystem 202 in any suitable manner as may serve a particular implementation. For example, fitting facility 306 may execute a version of a fitting software product associated with the primary database and primary schema to process the imported data during a fitting procedure. In some examples, the database partition may be deleted by database management facility 308 after the data has been merged.

Storage facility 312 may be configured to maintain patient data 314 representative of data descriptive of or otherwise associated with one or more cochlear implant patients and upgrade script data 316 representative of one or more upgrade scripts. Storage facility 312 may be configured to maintain additional or alternative data as may serve a particular implementation.

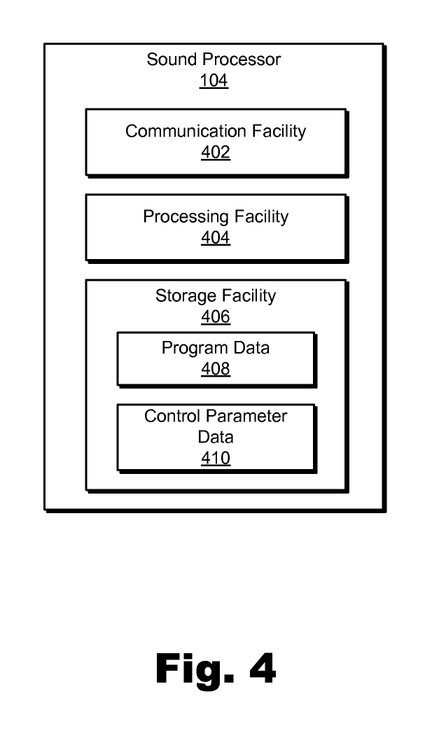

FIG. 4 illustrates exemplary components of sound processor 104. As shown in FIG. 4, sound processor 104 may include a communication facility 402, a processing facility 404, and a storage facility 406, any or all of which may be in communication with one another using any suitable communication technologies. Each of these facilities will now be described in more detail.

Communication facility 402 may be configured to facilitate communication between sound processor 104 and fitting subsystem 202. For example, communication facility 402 may be configured to facilitate electrical coupling of sound processor 104 to a CPI device in order to communicate with fitting subsystem 202. Communication facility 402 may be further configured to facilitate communication between sound processor 104 and implantable cochlear stimulator 110. For example, communication facility 402 may include transceiver components configured to wirelessly transmit data (e.g., control parameters and/or power signals) to implantable cochlear stimulator 110 and/or wirelessly receive data from implantable cochlear stimulator 110.

Processing facility 404 may be configured to perform one or more signal processing heuristics on an audio signal presented to the patient. For example, processing facility 404 may perform one or more pre-processing operations, spectral analysis operations, noise reduction operations, mapping operations, and/or any other types of signal processing operations on a detected audio signal as may serve a particular implementation. In some examples, processing facility 404 may generate and/or adjust one or more control parameters governing an operation of implantable cochlear stimulator 110 (e.g., one or more stimulation parameters defining the electrical stimulation to be generated and applied by implantable cochlear stimulator 110). In some examples, processing facility 404 may be configured to operate (e.g., process incoming audio signals and/or control implantable cochlear stimulator 110) in accordance with one or more sound processing programs provided by fitting subsystem 202 and/or otherwise stored within storage facility 406.

Storage facility 406 may be configured to maintain program data 408 representative of one or more sound processing programs and control parameter data 410 representative of one or more control parameters. Storage facility 406 may be configured to maintain additional or alternative data as may serve a particular implementation.

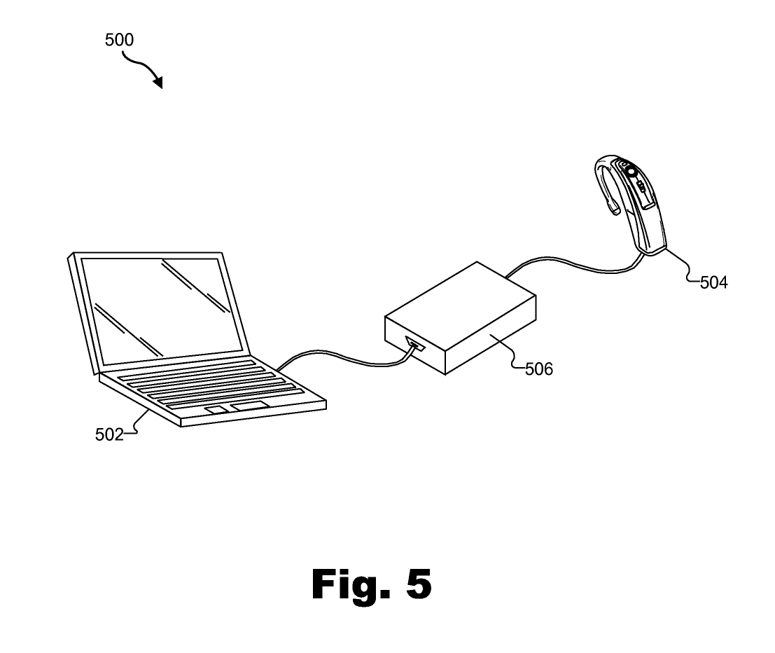

FIG. 5 illustrates an exemplary implementation 500 of fitting system 200. In implementation 500, a fitting station 502 may be selectively and communicatively coupled to a BTE unit 504 by way of a CPI device 506. BTE unit 504 is merely exemplary of the many different types of sound processors that may be used in accordance with the systems and methods described herein. Fitting station 502 may be selectively and communicatively coupled to any other type of sound processor as may serve a particular implementation.

Fitting station 502 may include any suitable computing device and/or combination of computing devices and be configured to perform one or more of the fitting operations described herein. For example, fitting station 502 may display one or more GUIs configured to facilitate interaction with patient data associated with one or more cochlear implant patients, selection of one or more sound processing programs by which BTE unit 504 operates, adjustment of one or more control parameters by which BTE unit 504 operates, and/or any other fitting operation as may serve a particular implementation. Fitting station 502 may be utilized by an audiologist, a clinician, and/or any other user to fit BTE unit 504 to a patient.

CPI device 506 may be configured to facilitate communication between fitting station 502 and BTE unit 504. In some examples, CPI device 506 may be selectively and communicatively coupled to fitting station 502 and/or BTE unit 504 by way of one or more ports included within fitting station 502 and BTE unit 504.

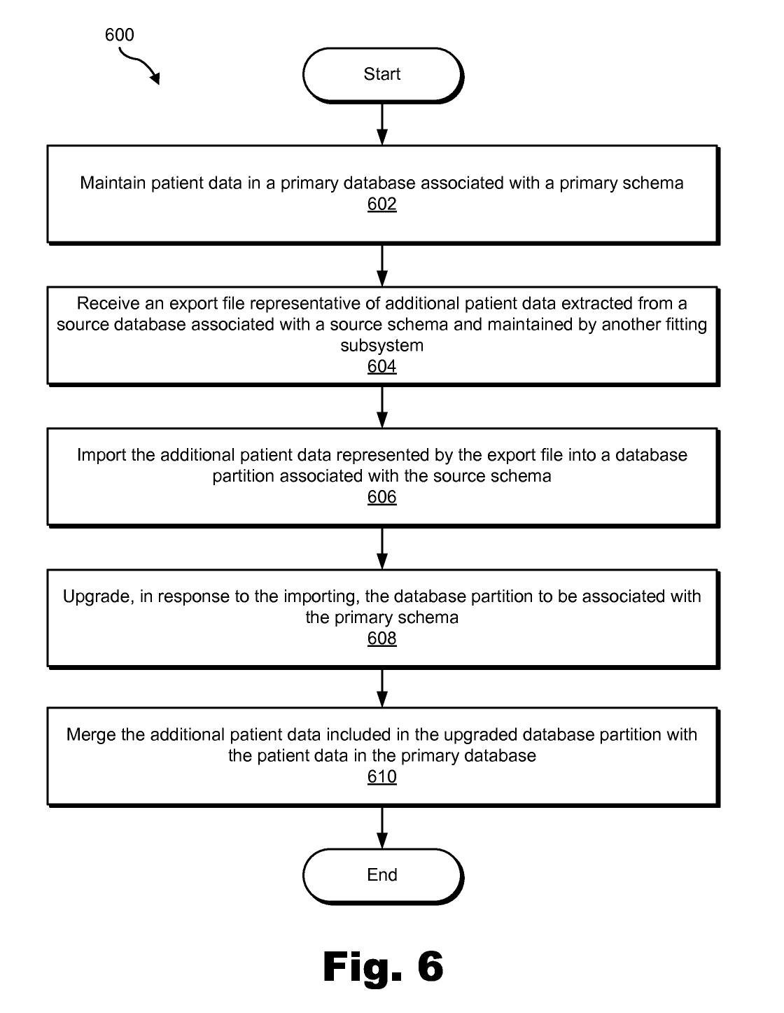

FIG. 6 illustrates an exemplary method 600 of importing patient data into a database associated with a cochlear implant fitting software product. While FIG. 6 illustrates exemplary steps according to one embodiment, other embodiments may omit, add to, reorder, and/or modify any of the steps shown in FIG. 6. One or more of the steps shown in FIG. 6 may be performed by any component or combination of components of fitting subsystem 202 and/or fitting station 502.

In step 602, a fitting subsystem maintains patient data in a primary database associated with a primary schema. The patient data may be associated with one or more patients and used to fit one or more cochlear implant systems to the one or more patients. Step 602 may be performed in any of the ways described herein.

In step 604, the fitting subsystem receives an export file representative of additional patient data extracted from a source database associated with a source schema and maintained by another fitting subsystem. The additional patient data may be associated with an additional patient (e.g., a patient not originally associated with the fitting subsystem). Step 604 may be performed in any of the ways described herein.

In step 606, the fitting subsystem imports the additional patient data represented by the export file into a database partition associated with the source schema. As described herein, the database partition may reside within the primary database and/or within another database separate from the primary database. Step 606 may be performed in any of the ways described herein.

In step 608, the fitting subsystem upgrades, in response the importing of the additional patient data, the database partition to be associated with the primary schema. Step 608 may be performed in any of the ways described herein.

In step 610, the fitting subsystem merges the additional patient data included in the upgraded database partition with the patient data in the primary database. Step 610 may be performed in any of the ways described herein. The additional patient data may then be used by the fitting subsystem to fit a cochlear implant system to the additional patient and/or in any other manner as may serve a particular implementation.

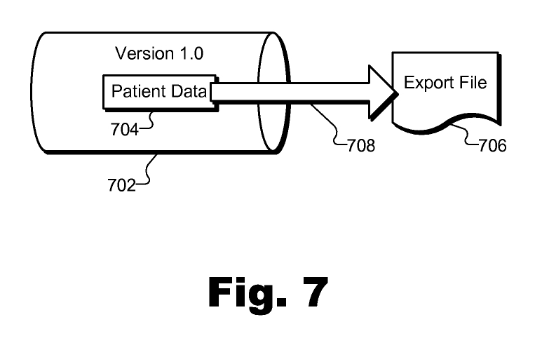

An example of the methods and systems described herein will now be provided in connection with FIGS. 7-13. The example is merely illustrative of the many different implementations of the methods and systems described herein.

FIG. 7 shows a source database 702 that may be associated with a fitting software product used by a fitting subsystem to fit a cochlear implant system to a patient. As shown in FIG. 7, source database 702 has a database version number of 1.0. The version of source database may be dependent on the version of its corresponding fitting software product and/or on any other factor as may serve a particular implementation. For example, the fitting software product associated with source database 702 may also have a version number of 1.0.

As described above, source database 702 may be associated with (e.g., defined by) a source schema, which may be dependent on the version of source database 702. For example, source database 702 may be subsequently upgraded from version 1.0 to version 1.1. The source schema associated with source database 702 may correspondingly change.

Patient data 704 associated with the patient may be stored within source database 702. In some examples, it may be desirable to transfer patient data 704 to another database (e.g., a database utilized by another fitting subsystem, referred to herein as a “recipient fitting subsystem”). To this end, patient data 704 may be extracted from source database 702 in the form of an export file 706. The generation of export file 706 is represented by arrow 708. Export file 706 may be provided to the recipient fitting subsystem in any suitable manner as may serve a particular implementation.

However, the database used by the recipient fitting subsystem to store patient data may be of a different version than source database 702. Hence, the schema associated with the database used by the recipient fitting subsystem may be different than the source schema.

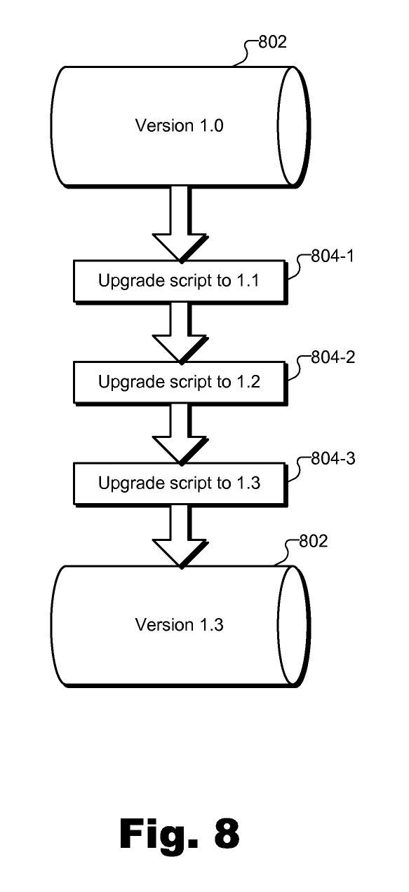

For example, FIG. 8 shows a primary database 802 associated with a fitting software product used by the recipient fitting subsystem. As shown in FIG. 8, primary database 802 may initially have a version number of 1.0. However, a series of upgrade scripts 804 (e.g., upgrade scripts 804-1 through 804-3) may be applied to primary database 802 to upgrade primary database 802 to version 1.3. Upgrade scripts 804 may be applied sequentially, as shown, and/or in any other manner as may serve a particular implementation. For example, in some alternative embodiments, a single upgrade script may be used to upgrade primary database 802 from version 1.0 to version 1.3. Once upgraded, the primary schema associated with primary database 802 may be different than the source schema associated with a version 1.0 database.

In some examples, the recipient fitting subsystem may receive export file 706 after primary database 802 has been upgraded to version 1.3. Because export file 706 was generated from a version 1.0 database, the patient data represented by export file 706 may not be compatible with primary database 802.

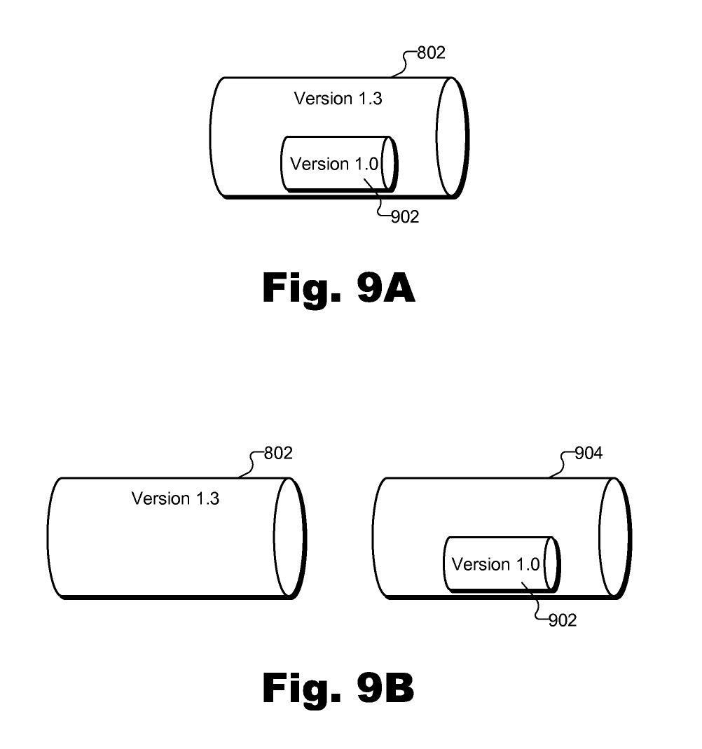

Hence, as described above, the recipient fitting subsystem may create a database partition associated with the source schema into which the patient data represented by export file 706 may be imported. The database partition may reside and/or be created within primary database 802 and/or within a database separate from primary database 802. To illustrate, FIG. 9A shows a database partition 902 residing within primary database 802 and FIG. 9B shows database partition 902 residing within a database 904 separate from primary database 802. Database partition 902 is labeled with “version 1.0” to indicate that it is associated with the source schema corresponding to a version 1.0 database. It will be assumed for the remainder of the present example that database partition 902 resides within primary database 802.

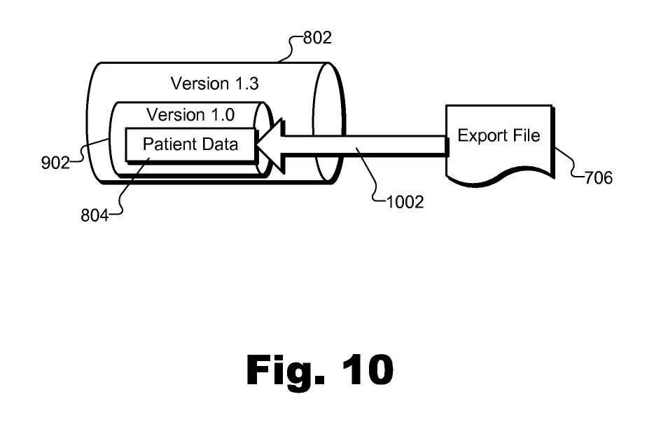

FIG. 10 shows that the recipient fitting subsystem may import patient data 804 represented by export file 706 into database partition 902. The importing is represented by arrow 1002 in FIG. 10 and may be performed in any suitable manner as may serve a particular implementation.

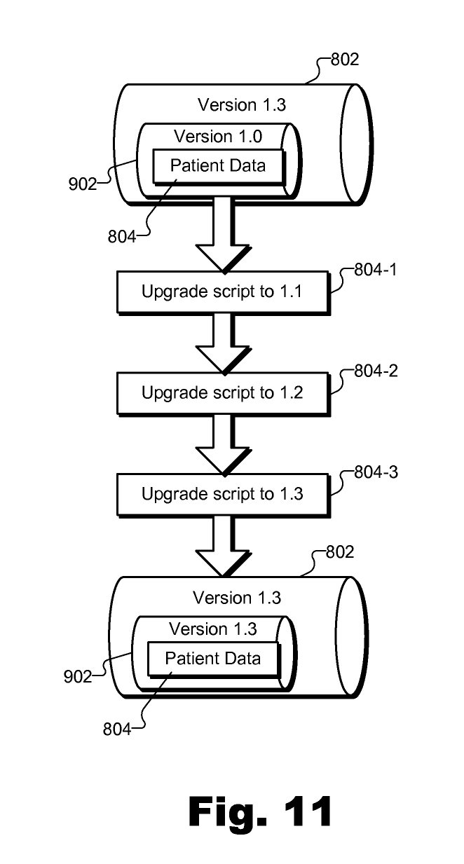

FIG. 11 shows that upgrade scripts 804 may be applied to database partition 902 to upgrade database partition from version 1.0 to version 1.3. Upgrade scripts 804 may be similar or identical to the upgrade scripts 804 shown in FIG. 8 and used to upgrade primary database 802 from version 1.0 to version 1.3.

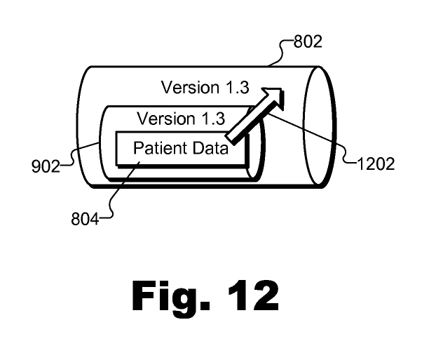

FIG. 12 shows that once database partition 902 has been upgraded to version 1.3, patient data 804 may be merged with patient data already maintained within primary database 802. The merging is represented by arrow 1202 in FIG. 12 and may be performed in any suitable manner as may serve a particular implementation.

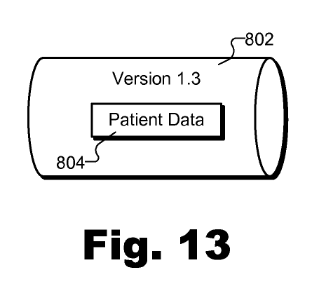

FIG. 13 shows primary database 802 after patient data 804 has been merged therein. FIG. 13 shows that database partition 902 has been deleted after the merging. Database partition 902 may alternatively be maintained within primary database 802 as may serve a particular implementation.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software) embodied on a non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions executable by one or more computing devices. In general, a processor (e.g., a microprocessor) receives instructions, from a tangible computer-readable medium, (e.g., a memory, etc.), and executes those instructions, thereby performing one or more processes, including one or more of the processes described herein. Such instructions may be stored and/or transmitted using any of a variety of known non-transitory computer-readable media.

A non-transitory computer-readable medium (also referred to as a processor-readable medium) includes any non-transitory medium that participates in providing data (e.g., instructions) that may be read by a computer (e.g., by a processor of a computer). Such a non-transitory medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of non-transitory computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other non-transitory medium from which a computer can read.

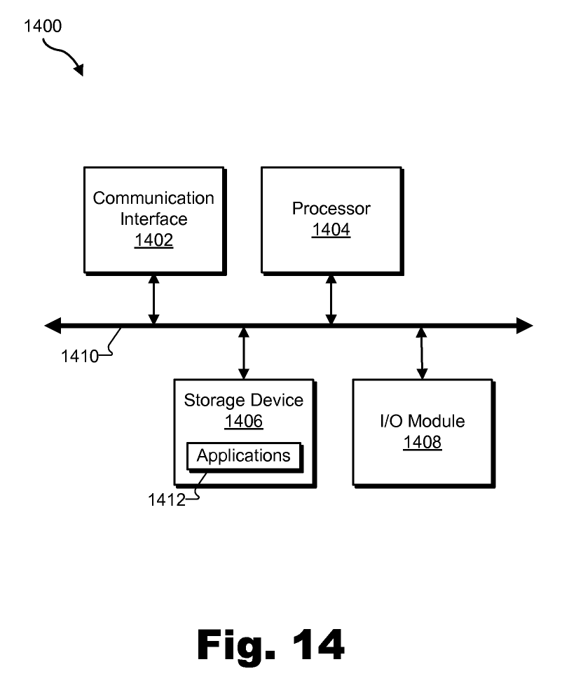

FIG. 14 illustrates an exemplary computing device 1400 that may be configured to perform one or more of the processes described herein. As shown in FIG. 14, computing device 1400 may include a communication interface 1402, a processor 1404, a storage device 1406, and an input/output (“I/O”) module 1408 communicatively connected via a communication infrastructure 1410. While an exemplary computing device 1400 is shown in FIG. 14, the components illustrated in FIG. 14 are not intended to be limiting. Additional or alternative components may be used in other embodiments. Components of computing device 1400 shown in FIG. 14 will now be described in additional detail.

Communication interface 1402 may be configured to communicate with one or more computing devices. Examples of communication interface 1402 include, without limitation, a wired network interface (such as a network interface card), a wireless network interface (such as a wireless network interface card), a modem, and any other suitable interface. Communication interface 1402 may additionally or alternatively provide such a connection through, for example, a local area network (such as an Ethernet network), a personal area network, a telephone or cable network, a satellite data connection, a dedicated URL, or any other suitable connection. Communication interface 1402 may be configured to interface with any suitable communication media, protocols, and formats, including any of those mentioned above.

Processor 1404 generally represents any type or form of processing unit capable of processing data or interpreting, executing, and/or directing execution of one or more of the instructions, processes, and/or operations described herein. Processor 1404 may direct execution of operations in accordance with one or more applications 1412 or other computer-executable instructions such as may be stored in storage device 1406 or another non-transitory computer-readable medium.

Storage device 1406 may include one or more data storage media, devices, or configurations and may employ any type, form, and combination of data storage media and/or device. For example, storage device 1406 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1406. For example, data representative of one or more executable applications 1412 (which may include, but are not limited to, one or more of the software applications described herein) configured to direct processor 1404 to perform any of the operations described herein may be stored within storage device 1406. In some examples, data may be arranged in one or more databases residing within storage device 1406.

I/O module 1408 may be configured to receive user input and provide user output and may include any hardware, firmware, software, or combination thereof supportive of input and output capabilities. For example, I/O module 1408 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1408 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1408 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1400. For example, one or more applications 1412 residing within storage device 1406 may be configured to direct processor 1404 to perform one or more processes or functions associated with communication facility 302, user interface facility 304, fitting facility 306, database management facility 308, import facility 310, communication facility 402, and/or processing facility 404. Likewise, storage facility 312 and/or storage facility 406 may be implemented by or within storage device 1406.

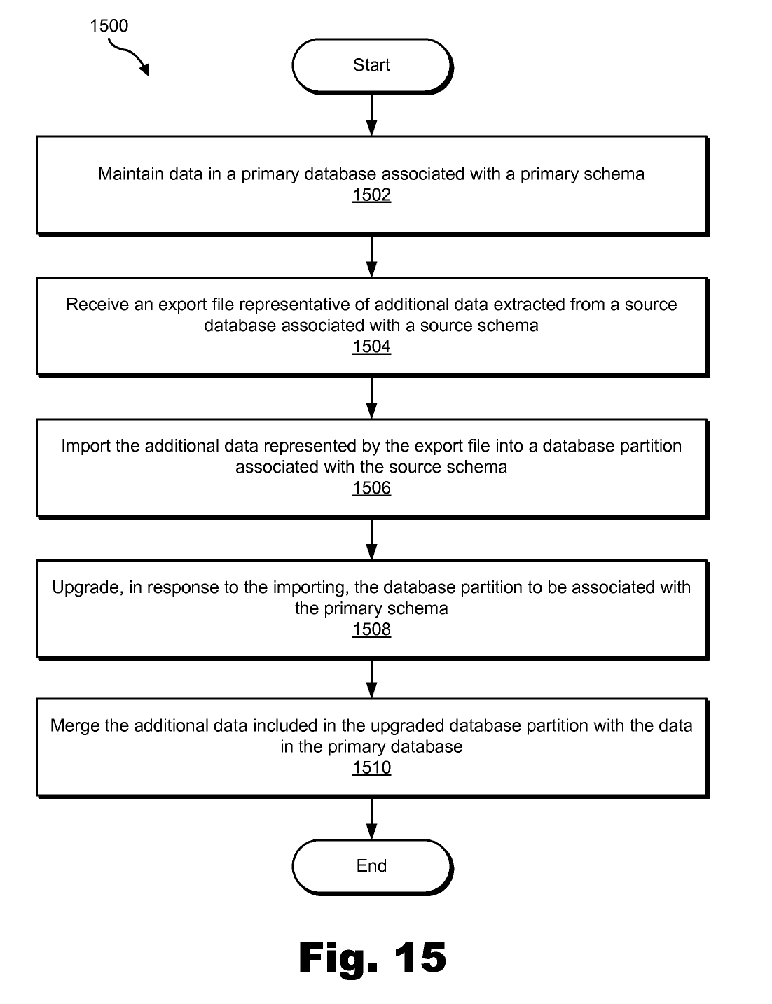

It will be recognized that the methods and systems described herein are not limited to cochlear implant fitting environments. Rather, any computing device associated with any type of software application and database may be configured to perform the methods and systems described herein. For example, FIG. 15 illustrates an exemplary method 1500 of importing data represented by an export file into a database that is associated with a different schema than that associated with the export file. While FIG. 15 illustrates exemplary steps according to one embodiment, other embodiments may omit, add to, reorder, and/or modify any of the steps shown in FIG. 15. One or more of the steps shown in FIG. 15 may be performed by one or more computing devices.

In step 1502, at least one computing device maintains data in a primary database associated with a primary schema. Step 1502 may be performed in any of the ways described herein.

In step 1504, the at least one computing device receives an export file representative of additional data extracted from a source database associated with a source schema. The source database may be maintained by another computing device, for example. Step 1504 may be performed in any of the ways described herein.

In step 1506, the at least one computing device imports the additional data represented by the export file into a database partition associated with the source schema. Step 1506 may be performed in any of the ways described herein.

In step 1508, the at least one computing device upgrades, in response to the importing, the database partition to be associated with the primary schema. Step 1508 may be performed in any of the ways described herein.

In step 1510, the at least one computing device merges the additional data included in the upgraded database partition with the data in the primary database. Step 1510 may be performed in any of the ways described herein.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
maintaining, by a fitting subsystem, patient data in a primary database associated with a primary schema, the patient data associated with one or more patients and used to fit one or more cochlear implant systems to the one or more patients;
receiving, by the fitting subsystem, an export file representative of additional patient data extracted from a source database associated with a source schema and maintained by another fitting subsystem, the additional patient data associated with an additional patient;
importing, by the fitting subsystem, the additional patient data represented by the export file into a database partition associated with the source schema;
upgrading, by the fitting subsystem in response to the importing, the database partition to be associated with the primary schema; and
merging, by the fitting subsystem, the additional patient data included in the upgraded database partition with the patient data in the primary database.

2. The method of claim 1, further comprising:
using, by the fitting subsystem subsequent to the merging, the additional patient data to fit a cochlear implant system to the additional patient.

3. The method of claim 1, further comprising:
executing, by the fitting subsystem, a version of a fitting software product associated with the primary database to process the additional patient data after the additional patient data is merged with the patient data in the primary database.

4. The method of claim 3, wherein the version of the fitting software product executed by the fitting subsystem is different than a version of the fitting software product executed by the another fitting subsystem.

5. The method of claim 1, further comprising:
detecting, by the fitting subsystem in response to the receiving of the export file, that the source schema is different than the primary schema, and
creating, by the fitting subsystem in response to the detecting, the database partition into which the additional patient data represented by the exported file is imported.

6. The method of claim 1, wherein the upgrading of the database partition to be associated with the primary schema comprises applying one or more upgrade scripts to the database partition.

7. The method of claim 1, further comprising performing the importing, upgrading, and merging without upgrading the export file to be associated with the primary schema.

8. The method of claim 1, further comprising deleting, by the fitting subsystem, the database partition after the additional patient data has been merged with the patient data in the primary database.

9. The method of claim 1, wherein the database partition resides within the primary database.

10. The method of claim 1, wherein the database partition resides within a database separate from the primary database.

11. The method of claim 1, wherein:
the source schema is associated with a first version of a fitting software product executed by the another fitting subsystem;
the primary schema is associated with a second version of the fitting software product executed by the fitting subsystem; and
the first version of the fitting software product is older than the second version of the fitting software product.

12. The method of claim 1, embodied as computer-executable instructions on at least one non-transitory computer-readable medium.

13. A method comprising:
maintaining, by at least one computing device, data in a primary database associated with a primary schema;
receiving, by the at least one computing device, an export file representative of additional data extracted from a source database associated with a source schema;
importing, by the at least one computing device, the additional data represented by the export file into a database partition associated with the source schema;
upgrading, by the at least one computing device in response to the importing, the database partition to be associated with the primary schema; and
merging, by the at least one computing device, the additional data included in the upgraded database partition with the data in the primary database.

14. The method of claim 13, further comprising:
executing, by the at least one computing device, a version of a software product associated with the primary database to process the additional data after the additional data is merged with the data in the primary database.

15. The method of claim 13, further comprising:
detecting, by the at least one computing device in response to the receiving of the export file, that the source schema is different than the primary schema, and
creating, by the at least one computing device in response to the detecting, the database partition into which the additional data represented by the exported file is imported.

16. The method of claim 13, wherein the upgrading of the database partition to be associated with the primary schema comprises applying one or more upgrade scripts to the database partition.

17. The method of claim 13, further comprising performing the importing, upgrading, and merging without upgrading the export file to be associated with the primary schema.

18. The method of claim 13, embodied as computer-executable instructions on at least one non-transitory computer-readable medium.

19. A system comprising:
a database management facility configured to maintain patient data in a primary database associated with a primary schema, the patient data associated with one or more patients and used to fit one or more cochlear implant systems to the one or more patients; and
an import facility communicatively coupled to the database management facility and configured to
receive an export file representative of additional patient data extracted from a source database associated with a source schema and maintained by another fitting subsystem, the additional patient data associated with an additional patient, and
import the additional patient data represented by the export file into a database partition associated with the source schema;
wherein the database management facility is further configured to
upgrade, in response to the importing, the database partition to be associated with the primary schema, and
merge the additional patient data included in the upgraded database partition with the patient data in the primary database.

20. The system of claim 19, further comprising a fitting facility communicatively coupled to the database management facility and configured to execute a version of a fitting software product associated with the primary database to process the additional patient data after the additional patient data is merged with the patient data in the primary database.
